(19) United States
(12) Patent Application Publication
(10) Pub. No.: US 2019/0107143 A1
(43) Pub. Date: Apr. 11, 2019

(54) CONSTANT TENSION TIE DOWN ASSEMBLY

(71) Applicant: ScreenerKing, LLC, Palm Springs, CA (US)

(72) Inventor: D. William Jackson, Palm Springs, CA (US)

(21) Appl. No.: 15/729,448

(22) Filed: Oct. 10, 2017

(51) Int. Cl. F16B 43/00; B07B 1/48

(52) U.S. Cl. CPC F16B 43/001; B07B 1/48

(57) ABSTRACT

The present disclosure generally relates to devices, designs, and methods of using a constant tension tie down assembly for holding a separation screen or sieve. The constant tension tie down assembly applies constant tension to a separation screen or sieve while decreasing wear and tear on the screen.

### BACKGROUND OF THE INVENTION

Separation screens are commonly used in various ways to separate particles from each other and from liquids. These screens are commonly used in gyratory devices as well as vibratory devices. Separation devices rely on rapid movement to separate particles. Over time, this rapid movement may cause mechanical failure in components such as the separation screens.

Separation screens are traditionally held in place using center tie down assemblies. Traditional center tie down assemblies secure the screen to the separation particle using a series of rods, washers, and nuts. These traditional tie down assemblies do not provide any means for dampening the vibrational or gyrational forces. Because traditional tie down assemblies have several metal components touching one another and moving against one another, mechanical failure is inevitable. Additionally, traditional tie down assemblies do not keep the screen in constant tension when the machine is in operation. Having a slack screen adversely affects a device's ability to separate particles. Further, having a slack screen allows unwanted screen movement that may contribute to early mechanical failure.

What is needed is a center tie down assembly that can provide constant tension while dampening vibrational and gyrational forces on the screen. The assembly should decrease the amount of impact between the screen and the center tie down assembly. The assembly should also be configured to keep the screen in constant tension.

### SUMMARY OF THE INVENTION

The present application relates to a center tie down assembly for use with a mechanical separator that has a screen or sieve. The constant tension tie down assembly generally supports a separation screen by providing a center column in the form of a rod that is placed through the center of a separation screen. Once the rod is placed through the separation screen, the separation screen divides the rod into a top end and a bottom end. The top end of the rod may first have a first cushioning pad placed on it. The top end of the rod may also have a nut and a cap placed on it. The first cushioning pad is placed on the assembly so that it is in contact with the separation screen and the top nut. The cap is then placed on top of the top nut.

The bottom end of the rod may have a cushion placed on it so the cushion is in contact with the separation screen, allowing the screen to rest on the cushion. Next, a second cushioning pad is placed on the rod so that the second cushioning pad is in contact with the cushion. The assembly may additionally include a separator that is in contact with the second cushioning pad.

The assembly may also include a first nut beneath the washer, wherein the first nut is in contact with the washer. The assembly may also include a second nut beneath the first nut. The assembly may also include a third nut beneath the second nut, wherein the first, second and third nuts are spaced apart from one another.

### BRIEF DESCRIPTION OF THE DRAWINGS

The following drawings form part of the present specification and are included to demonstrate certain aspects of the present invention. The invention may be better understood by reference to one or more of these drawings in combination with the detailed description of specific embodiments presented herein.

FIG. 1 illustrates an exploded view of the continuous tension tie down assembly in one embodiment.

FIG. 2 illustrates an exploded view of the continuous tension tie down assembly with a separating screen in one embodiment.

FIG. 3 illustrates a bottom view of the continuous tension tie down assembly with a separating screen in one embodiment.

FIG. 4 illustrates a top view of the continuous tension tie down assembly with a separating screen in one embodiment.

FIG. 5 illustrates an exploded perspective view of the continuous tension tie down assembly in one embodiment.

FIG. 6 illustrates an assembled side view of the continuous tension tie down assembly in one embodiment.

### DETAILED DESCRIPTION

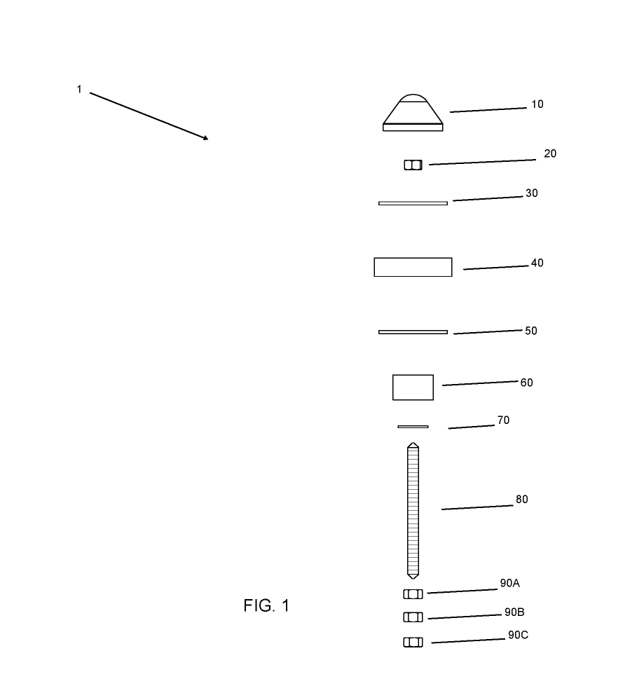

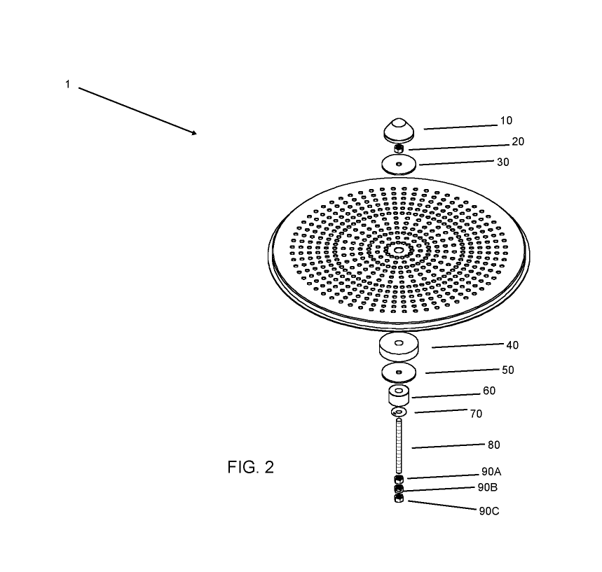

The invention is to a constant tension tie down assembly as shown in FIGS. 1-6 and a method for using the constant tension tie down assembly to provide constant tension tie down for a separation screen. Specifically, the invention is to a constant tension tie down that is an improvement of traditional tie down assemblies that do not provide constant tension. The invention also provides improvement over traditional tie downs because the invention extends the life of separation screens.

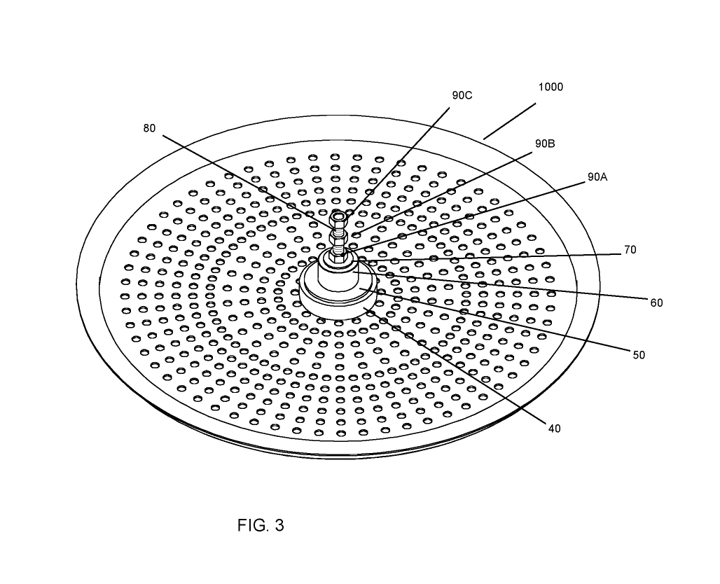

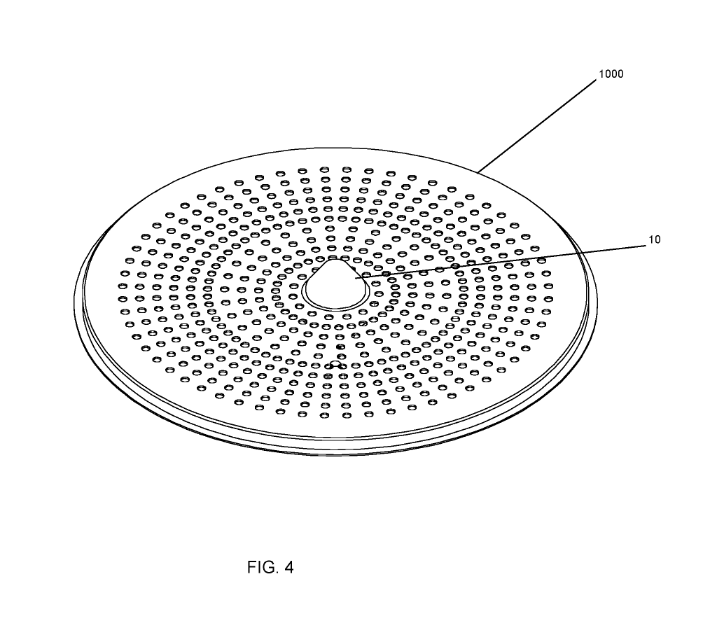

The constant tension tie down assembly 1 may be configured for holding a separation screen in constant tension. For example, as shown in FIGS. 3 and 4, the constant tension tie down assembly 1 may have a separation screen between at least two of the constant tension tie down assembly's components.

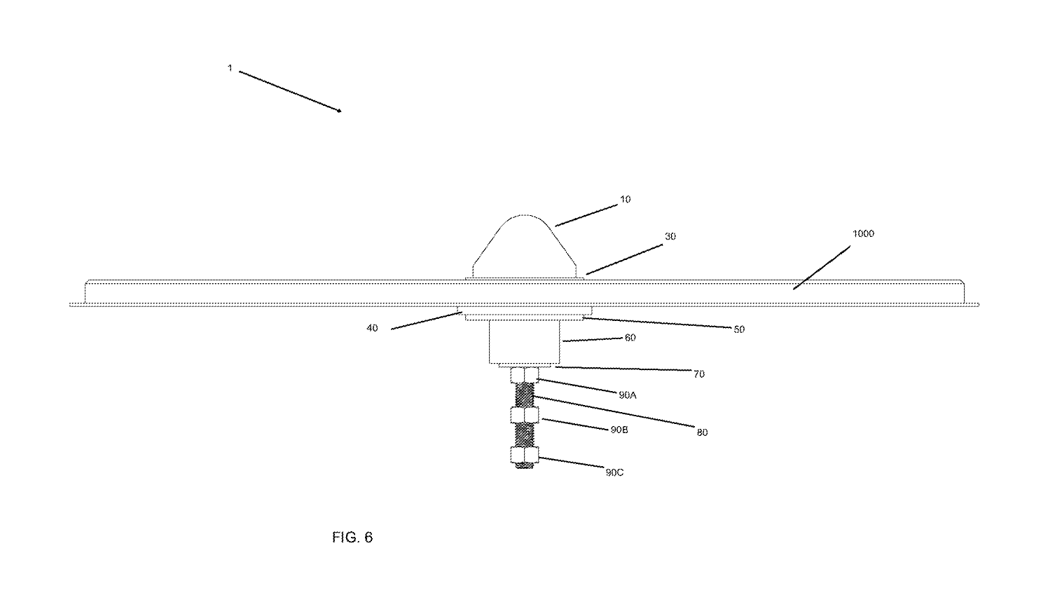

The constant tension tie down assembly 1 may include a rod 80 that is the central holder of the other constant tension tie down assembly 1 components. As shown in FIG. 6, the rod may have components placed on it so the screen 1000 is supported between at least two components. The rod may have a cap, a first nut, a first cushion pad 30, a cushion 40, a second cushion pad 50, a spacer 60, a washer 70, and bottom nuts 90A-C placed on it with the screen placed on the rod between at least two of the components.

The constant tension tie down assembly 1 has a rod 80. The rod 80 is a cylindrical member having a first end and a second end. The rod may have threads for accepting nuts, or other components that can be screwed onto a threaded rod. The rod 80 may be a metal such as stainless steel, bronze, copper, titanium, steel, iron, or combinations thereof. One of skill in the art will recognize that circular separators are used in many industries including the food industry. Because the constant tension tie down assembly 1 may be used in the food industry, the rod may be any material known in the art that is food grade.

The constant tension tie down assembly 1 may have a cap 10 that is secured to the top end of the rod 80. The cap may have an interior area that is threaded to receive the rod. By way of non-limiting example, the cap may be an acorn nut or a cap nut with a domed top over the end of the fastener. Like the rod 80, the cap 10 may be a metal such as stainless steel, bronze, copper, titanium, steel, iron, or combinations thereof. In some embodiments, the cap 10 is not threaded but fits over a first nut 20 that is then screwed onto the first end of the rod 80. One of skill in the art will recognize that cap 10 may be any material known in the art.

The constant tension tie down assembly 1 may have one or more cushion pads 30 and 50. The first cushion pad 30 may receive the rod 80 so that the cushion pad 30 is on top of a separator screen 1000. The second cushion pad 50 also receives the rod 80, but may be in a position below a screen separator 1000. As shown in FIG. 6, the screen separator may be placed between the first cushion pad 30 and a cushion 40. In some embodiments, the separator screen may be placed between the two cushion pads 30 and 50. The cushion pads are made of a material that dampens vibration so that the separator screen is not damaged. The cushion pads may be neoprene rubber. The cushion pads may also be a plastic. One of skill in the art will understand that the cushion pads 30 and 50 may be any material known in the art. The cushion pads may be circles. One of skill in the art will appreciate that the cushion pads may be square, triangle, hexagon, octagon, or any other shape known in the art.

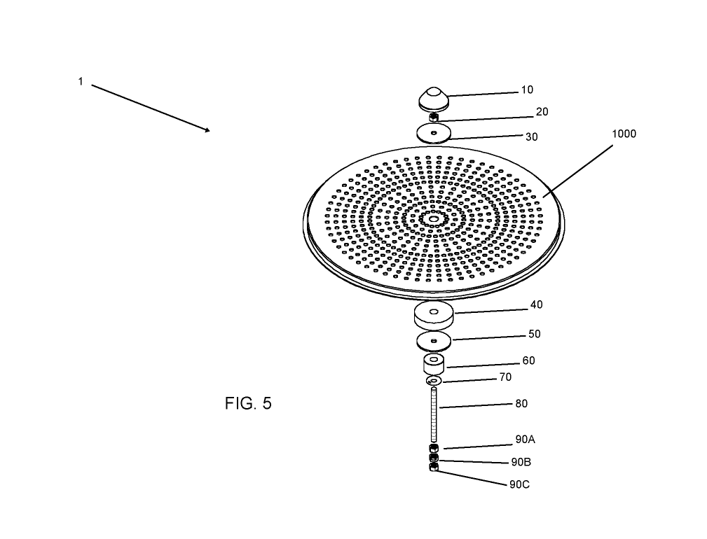

The constant tension tie down assembly 1 may have one or more cushions 40. The cushion 40 may act to reduce wear and tear on the screen separator 1000 by dampening vibration or other movements. The cushion 40 may have a cylindrical shape with an annular hole as seen in FIG. 5. The hole in the cushion may be sized to accept the rod 80. The cushion may be threaded to securely and tightly fit on the rod 80. In some embodiments, the cushion 40 may not have threading so that the cushion is allowed freedom of movement when the separator is in operation. The cushion 40 may be neoprene rubber. The cushion 40 may also be a plastic. One of skill in the art will understand that the cushion 40 may be any material known in the art. The cushion may be circles. One of skill in the art will appreciate that the cushion may be square, triangle, hexagon, octagon, or any other shape known in the art.

The constant tension tie down assembly 1 may have one or more spacers 60. The spacer may be used for keeping the first screen spaced apart from a second screen. The spacer 60 may have a cylindrical shape with an annular hole as seen in FIG. 5. The hole in the spacer may be sized to accept the rod 80. The spacer 60 may have internal threading that allows the spacer 60 to be screwed onto the rod 80 as shown in FIG. 6. The spacer 60 may be metal such as stainless steel, bronze, copper, titanium, steel, iron, or combinations thereof. In some embodiments, the spacer may be a plastic or rubber. One of skill in the art will appreciate that the spacer 60 may be any material known in the art.

The constant tension tie down assembly 1 may have one or more washers 70. As shown in FIGS. 5 and 6, the washer may be placed on the bottom end of rod 80 between the spacer 60 and a bottom nut 90A. The washer 70 may be held in contact with the spacer 60 by screwing the nut 90A onto the rod so that the nut abuts a first side of the washer 70 and the spacer abuts the second side of the washer 70. In this regard, the washer 70 helps distribute the pressure that the nut 90A places on the spacer 60. The washer may be metal such as stainless steel, bronze, copper, titanium, steel, iron, or combinations thereof. One of skill in the art will appreciate that the washer 70 may be any material known in the art. One of skill in the art will also appreciate that the washer may be plain, spring, locking or any type of washer known in the art.

The constant tension tie down assembly 1 may have one or more bottom nuts 90A-C. As shown in FIGS. 5 and 6, the nuts 90A-C may be placed on the bottom end of rod 80. Nut 90A may be screwed onto rod 80 so that it abuts the washer 70. Nuts 90B and 90C may also be screwed onto rod 80, leaving space between each nut 90A-C. The nuts 90A-C may be metal such as stainless steel, bronze, copper, titanium, steel, iron, or combinations thereof. One of skill in the art will appreciate that the nuts 90A-C may be any material known in the art. The nuts 90A-C may be cage nuts, spring nuts, cap nuts, captive nuts, castle nuts, coupling nuts, flange nuts, forged eye nuts, freight car nuts, heavy hex nuts, hex nuts, high nuts, jam nuts, lock nuts, panel nuts, square nuts, weld nuts, or combinations thereof. One of skill in the art will appreciate that the nuts may be any nut known in the art.

Method

As shown in FIGS. 3 and 6, the constant tension tie down assembly 1 is shown with all components assembled and with a separating screen 1000. As shown, the rod 80 is threaded or placed through a central aperture in the separating screen 1000. The rod is then secured to the separating screen 1000 by placing the cushion, second cushioning pad, spacer, washer, and nuts 90A-C on the bottom end of the rod 80. Then the first cushioning pad is placed on top of the separating screen 1000. Then the first nut 20 is placed on the rod 80. Then the cap 10 is placed on the rod 80. In some embodiments, the cap 10 has internal threads that allow it to be placed on the top end of the rod 80 by screwing the cap 10 on.

1. A constant tension tie down assembly, designed to hold and stabilize a separation screen, the assembly comprises:
at least one rod;
at least one nut;
at least one washer;
at least one cushioning pad to keep the screen in a horizontal position;
at least one cap;
at least one spacer; and
at least one cushion.

2. The assembly of claim 1 wherein the rod is threaded.

3. The assembly of claim 1 wherein the assembly has four nuts.

4. The assembly of claim 1 wherein the washer is metal.

5. The assembly of claim 1 wherein the washer is a flat washer.

6. The assembly of claim 1 wherein the separator is a plastic.

7. The assembly of claim 1 wherein the components are placed on the rod in the following order: the cap, a first nut, a first cushioning pad, the cushion, a second cushioning pad, the spacer, the washer nut, a second nut, and a third nut.

8. The assembly of claim 1 wherein a separation screen is placed between at least two components.

9. A constant tension tie down assembly, designed to hold and stabilize a separation screen, the assembly comprising:
a threaded rod having a first end and a second end;
a domed nut screwed onto the first end of the threaded rod;
a first nut screwed onto the first end of the threaded rod;
a first cushioning pad placed onto the first end of the rod, wherein the cushioning pad is in contact with the first nut;
a cushion placed onto the rod;
a separation screen between the cushioning pad and the cushion, wherein the rod runs through the separation screen, wherein the separation screen is in contact with the first cushioning pad and the cushion;
a second cushioning pad, wherein the second cushioning pad is in contact with the cushion;
a spacer beneath the second cushioning pad, wherein the spacer is in contact with the second cushioning pad;
a washer beneath the spacer, wherein the washer is in contact with the spacer;
a first nut beneath the washer, wherein the first nut is in contact with the washer;
a second nut beneath the first nut; and
a third nut beneath the second nut, wherein the first, second and third nuts are spaced apart from one another.

10. A method of using a constant tension tie down assembly consisting of:
placing a threaded rod through a screen or sieve so that the rod is divided into a top end and a bottom end;
placing a cap, a nut, and a first cushioning pad on the top end of the rod;
placing a cushion, a second cushioning pad, a separator, a washer, and at least three nuts on the bottom end of the rod.
